(19) United States
(12) Patent Application Publication
(10) Pub. No.: US 2012/0052387 A1
(43) Pub. Date: Mar. 1, 2012

(54) LI-ION BATTERY

(76) Inventor: Chien-Min SUNG, Danshuei Township (TW)

(21) Appl. No.: 12/938,625

(22) Filed: Nov. 3, 2010

(30) Foreign Application Priority Data
Sep. 1, 2010 (TW) 099129469

(51) Int. Cl. H01M 4/38; H01M 4/58; H01M 4/583

(52) U.S. Cl. 429/218.1; 429/231.8; 429/223; 429/231.9

(57) ABSTRACT

The present invention relates to an Li-ion battery, which comprises: a positive electrode; a negative electrode; and an Li-ion electrolyte contacting with the positive electrode and the negative electrode, wherein the negative electrode has a graphene multi-layered structure, the graphene multi-layered structure comprises plural 2D graphene layers, and plural Ni layers interposed between the 2D graphene layers, and Li-ions completely intercalate or de-intercalate between the graphene layers.

### BACKGROUND OF THE INVENTION

1. Field of the Invention

The present invention relates to an Li-ion battery and, more particularly, to an Li-ion battery with a negative electrode having a graphene multi-layered structure to improve the discharge rate of the battery.

2. Description of Related Art

The phenomenal popularity of products, such as cell phones, notebooks, video cameras and electric vehicles in recent years has resulted in a corresponding demand for rechargeable batteries. The commercially available secondary batteries are mainly divided into Ni—Cd batteries, NiMH batteries, Li-ion batteries and Li-polymer batteries.

Li-ion batteries are developed from Li metal batteries, and the main material of the negative electrode is carbon. During the battery charging process, Li ions intercalate into the multi-layered structure of the negative electrode, and there is no Li metal formed; hence, the safety of the batteries can be greatly improved. In addition, comparing to other secondary batteries, the Li-ion batteries have the advantages of high energy density, high efficiency, long lifetime, high working voltage, and stable discharge performance. Therefore, the Li-ion batteries are widely applied to various devices.

The conventional Li-ion battery comprises: a positive electrode, a negative electrode, a separator, and an Li-ion electrolyte. The general material of the positive electrode is Lithium cobalt(III) oxide; and the negative electrode is prepared by a lamination of graphite powder. The mechanism of the Li-ion battery is represented by the following equations.

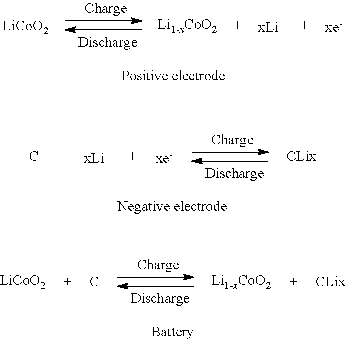

Therefore, during the discharge process of the Li-ion battery, the negative electrode facing to the Li-ion electrolyte is an anode, and the positive electrode facing to the Li-ion electrolyte is a cathode.

However, the size of the graphite crystal of the graphite powder used for the negative electrode is in a range of micro-meter, so Li ions have to change their route during the intercalation or de-intercalation process. This means that the diffusion rate of the Li ions is very slow; consequently, the Li-ion battery may have the disadvantage of being under-charged or of having slow discharge.

The property of Li-ion battery depends on the rate of the intercalation or de-intercalation of Li ions into the layered electrode whereby the storage capacity of Li-ion battery is still not big enough, and the charge/discharge efficiency of which is not good enough, due to the slow rate of the intercalation or de-intercalation of Li ions. Therefore, it is desirable to provide an Li-ion battery, which has an increased rate of intercalation or de-intercalation of Li ions, in order to improve the charge/discharge efficiency of the Li-ion battery.

### SUMMARY OF THE INVENTION

The object of the present invention is to provide an Li-ion battery with a negative electrode having a graphene multi-layered structure to increase the charge/discharge efficiency of the Li-ion battery.

To achieve the object, the Li-ion battery of the present invention comprises: a positive electrode; a negative electrode; and an Li-ion electrolyte contacting with the positive electrode and the negative electrode, wherein the negative electrode has a graphene multi-layered structure, the graphene multi-layered structure comprises plural 2D graphene layers, and Li ions intercalate or de-intercalate between the graphene layers.

The negative electrode of the Li-ion of the present invention has a multi-layered structure, so a great quantity of Li ions can be stored between the 2D graphene layers. Theoretically, the storage of the Li ions can be one sixth of the carbon amount, and an intermetallic compound, LiC₆, is formed. In addition, an intermetallic compound, LiC₃, may be formed when Li ions are stored between two sides of the 2D graphene layers. Furthermore, the graphene multi-layered structure has high crystallinity, and Li ions do not have to change their route during the intercalation or de-intercalation process. Therefore, Li ions can quickly distribute from the negative electrode, and the discharge efficiency of the Li ion battery can be improved.

In addition, the Li-ion battery of the present invention may further comprise: a separator located between the positive electrode and the negative electrode. The Li-ion electrolyte can be any electrolyte containing Li ions used in the art, and can be a non-aqueous electrolyte.

Furthermore, according to the Li-ion battery of the present invention, the graphene multi-layered structure may further comprises plural Ni layers, and the Ni layers are interposed between the 2D graphene layers.

According to the Li-ion battery of the present invention, the graphene multi-layered structure may further comprise plural Na ions (Na⁺), plural K ions (K⁺), or plural Na ions and K ions, which are intercalated between the 2D graphene layers. Preferably, the graphene multi-layered structure comprises plural Na ions. When the Na ions, and/or K ions are absorbed into the 2D graphene layers, the gap between the 2D graphene layers can be increased due to the large size of these metal ions. The moving rate of the Li ions can be accordingly increased, and the capacity and the voltage of the battery can be enhanced.

In addition, according to the Li-ion battery of the present invention, the material and the structure of the positive electrode is not particularly limited, and can be any material used in the art, such as the oxides of LiCo, Mn, Fe, or P. Preferably, the positive electrode may also have a multi-layered structure, and Li ions can intercalate or de-intercalate between layers of the multi-layered structure of the positive electrode. The material of the positive electrode of the Li-ion battery of the present invention may be oxides with laminate structure, such as talc, pyrophyllite, or clay minerals. In addition, the clay minerals can be Montmorillonite, Kaolinite, Illite, or Smectite. When the material of the positive electrode of the Li-ion battery has a laminate structure, the moving rate of the Li ions can also be increased, and the capacity and the voltage of the battery can be enhanced.

According to the Li-ion battery of the present invention, the thickness of the negative electrode is not particularly limited. Preferably, the thickness of the negative electrode is 50-1000 μm. More preferably, the thickness of the negative electrode is 50-500 μm.

The graphene multi-layered structure can be used to store atoms or ions. Hence, the graphene multi-layered structure can be used to store not only Li ions, but also other atoms or ions, such as K⁺, Na⁺, and H₂. In order to store H₂ between the 2D graphene layers, a graphite intercalated compound (GIC) is first formed, i.e. a metal ion that easily loses electrons, such as Li⁺, N⁺, K⁺, are intercalated between the 2D graphene layers. Then, H₂ is absorbed into the 2D graphene layers by the capillary force, because these metal ions can absorb H₂. The metal ions and H₂ may further form a metal hydride, such as LiH. When Li ions and H₂ are stored between the 2D graphene layers, an Li—H hybrid battery is obtained. The Li—H hybrid battery is a combination of an Li-ion battery and a hydrogen fuel cell. When the Li—H hybrid battery is in operation, the battery's temperature rises to about 50° C., H₂ is first released, and then Li ions are released.

In addition, the graphene multi-layered structure not only can be used to form the Li—H hybrid battery, but also can be applied to the hydrogen fuel cell. First, the graphene multi-layered structure is immersed into a warm concentrated-acid such as sulfuric acid and nitrohydrochloric acid. The acidic gas such as SO₂ may be inserted between the 2D graphene layers to form an intercalation compound. Then, H₂ is injected into the intercalation compound under pressure, and H₂ is absorbed by the acidic gas (such as SO₂+H₂). The H₂ absorbed between the 2D grapheme layers may be released under heat to serve as a power of the fuel cell.

### BRIEF DESCRIPTION OF THE DRAWINGS

FIG. 1A is a perspective view of a graphene film with a graphene multi-layered structure of the present invention;

FIG. 1B is a perspective view of a graphene film of the present invention, which has plural Ni layers and plural graphene layers interposed between each other;

FIG. 2 is a perspective view of an Li-ion battery of an Embodiment 5 of the present invention; and

FIG. 3 is a perspective view of a graphene multi-layered structure containing Li ions stored between 2D graphene layers.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1—Preparation of a Graphene Film

The graphene film of the present embodiment is prepared with a solid-phase synthesis, and the method thereof is described as follow.

First, a quartz plate is coated with graphite powders having high purity to form a graphite powder layer on the quartz plate. The quartz plate coated with a graphite powder layer is placed in a tube furnace. A vacuum is applied to the tube furnace to about 10⁻⁵ Torr.

Then, the quartz plate coated with the graphite powder layer is heat-treated at 1200° C. to transform the graphite powder layer into a graphene film. After the furnace has slowly cooled, the resulting graphene film is peeled from the cooled quartz plate to obtain a graphene film with a graphene multi-layered structure.

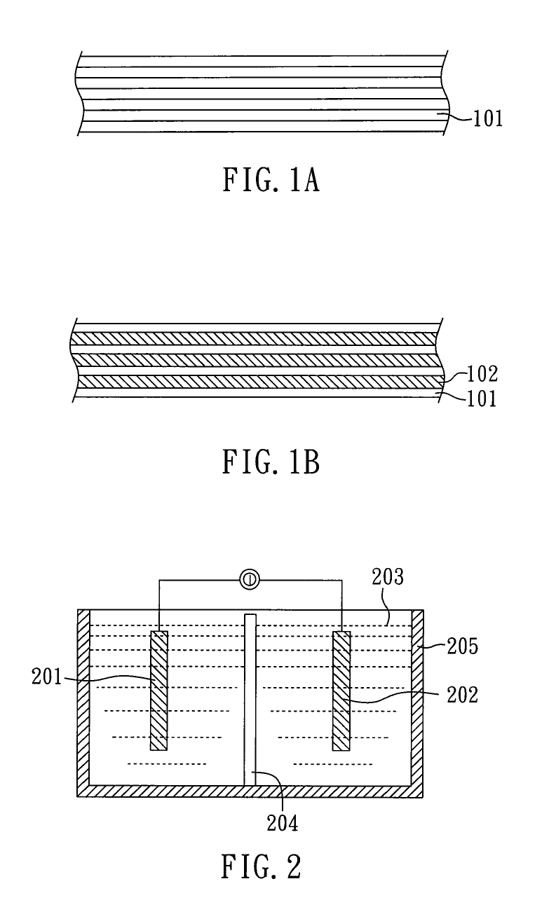

As shown in FIG. 1A, the graphene film with a graphene multi-layered structure of the present embodiment comprises: plural 2D graphene layers 101.

### Embodiment 2—Preparation of a Graphene Film

The graphene film of the present embodiment is prepared with a solid-phase synthesis, and the method thereof is described as follow.

First, a nickel plate is coated with graphite powders having high purity to form a graphite powder layer on the nickel plate. The nickel plate coated with a graphite powder layer is placed in a tube furnace. A vacuum is applied to the tube furnace to about 10⁻⁵ Torr. Herein, the nickel plate can be used as a catalyst for transforming the graphite powders into graphene.

Then, the nickel plate coated with the graphite powder layer is heat-treated at 1200° C. to transform the graphite powder layer into graphene layers with almost continuous crystal lattice, and the graphene layers are formed on two sides of the nickel plate. After the furnace has slowly cooled, the resulting graphene film is peeled from the cooled nickel plate to obtain a graphene film with a graphene multi-layered structure.

As shown in FIG. 1B, the graphene film with a graphene multi-layered structure of the present embodiment comprises: plural 2D graphene layers 101 (3 μm); and plural Ni layers 102, wherein the Ni layers 102 are interposed between the 2D graphene layers 101.

### Embodiment 3—Preparation of a Graphene Film

The method for manufacturing the graphene film with a graphene multi-layered structure of the present embodiment is the same as that described in the Embodiment 2, except that a process for removing Ni layers is performed after the graphene film is formed.

The graphene film with Ni layers and 2D graphene layers of the Embodiment 2 are immersed into an acid, such as sulfuric acid, nitric acid, or hydrochloric acid, to remove the nickel. After a washing process, a graphene film with a graphene multi-layered structure is obtained. The structure of the graphene film of the present embodiment is similar to that of the Embodiment 1, and comprises plural 2D graphene layer 101, as shown in FIG. 1A.

### Embodiment 4—Preparation of a Graphene Film Intercalated with Na or K Ion

The method for manufacturing the graphene film with a graphene multi-layered structure of the present embodiment is the same as that described in the Embodiment 3, except that a process for inserting Na ions is performed after the Ni layers are removed.

Under inert gas, the graphene film of the Embodiment 3 is immersed into an electrolyte containing Na ions or K ions. The Na ions or K ions are absorbed into the 2D graphene layers to increase the gap between the 2D graphene layers.

Hence, the graphene film with a graphene multi-layered structure of the present embodiment comprises plural Na ions or K ions intercalated between the 2D graphene layers. Hence, the gap between the 2D graphene layers is increased, and there is an abundant space for the metal ions to move therein.

### Embodiment 5—Li-Ion Battery

The Li-ion battery of the present embodiment can be manufactured by the method generally known in the art. Hence, except the method for manufacturing the negative electrode, other processes are omitted.

The Li-ion battery of the present embodiment is manufactured with the graphene film with a graphene multi-layered structure of the Embodiment 3. The graphene film is cut with a Wire Cut Electrical Discharge Machining (Wire-EDM) to use as a negative electrode of the Li-ion battery. In the present embodiment, the material of the positive electrode is talc.

A separator is inserted between the positive electrode and the negative electrode, and then an Li-ion electrolyte is injected between the positive electrode and the negative electrode to form an Li-ion battery.

As shown in FIG. 2, the Li-ion battery of the present embodiment comprises: a positive electrode 201; a negative electrode 202; and an Li-ion electrolyte 203 contacting with the positive electrode 201 and the negative electrode 202, wherein the negative electrode 202 has a graphene multi-layered structure, the graphene multi-layered structure comprises plural 2D graphene layers, and Li ions intercalate or de-intercalate between the graphene layers.

Furthermore, the Li-ion battery of the present embodiment further comprises: a separator 204 located between the positive electrode 201 and the negative electrode 202. In addition, the positive electrode 201, the negative electrode 202, an Li-ion electrolyte 203 and the separator 204 are installed in a battery can 205.

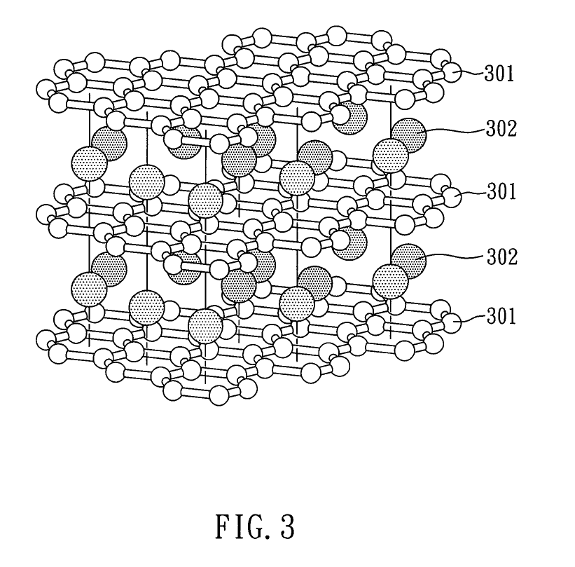

In order to clearly understand the storage of Li ions in the Li-ion battery of the present embodiment, FIG. 3 is a perspective view of a graphene multi-layered structure containing Li ions stored between 2D graphene layers. As shown in FIG. 3, Li ions 302 are stored between the 2D graphene layers 301. Theoretically, the storage of the Li ions can be one sixth of the carbon amount to form an intermetallic compound, LiC₆.

### Embodiment 6—Li-Ion Battery

The structure of the Li-ion battery and the method for manufacturing the same of the present embodiment is the same as that described in the Embodiment 5, except that the graphene layer of the Embodiment 3 is substituted with the graphene layer intercalated with Na ions of the Embodiment 4 to form a negative electrode of the Li-ion battery.

Although the present invention has been explained in relation to its preferred embodiment, it is to be understood that many other possible modifications and variations can be made without departing from the scope of the invention as hereinafter claimed.

What is claimed is:

1. An Li-ion battery, comprising:
a positive electrode;
a negative electrode; and
an Li-ion electrolyte contacting with the positive electrode and the negative electrode,
wherein the negative electrode has a graphene multi-layered structure, the graphene multi-layered structure comprises plural 2D graphene layers, and Li ions intercalate or de-intercalate between the graphene layers.

2. The Li-ion battery as claimed in claim 1, further comprising a separator located between the positive electrode and the negative electrode.

3. The Li-ion battery as claimed in claim 1, wherein the graphene multi-layered structure further comprises plural Ni layers, and the Ni layers are interposed between the 2D graphene layers.

4. The Li-ion battery as claimed in claim 1, wherein the graphene multi-layered structure further comprises plural Na ions, plural K ions, or plural Na ions and K ions, which are intercalated between the 2D graphene layers.

5. The Li-ion battery as claimed in claim 1, wherein the graphene multi-layered structure further comprises plural Na ions, which are intercalated between the 2D graphene layers.

6. The Li-ion battery as claimed in claim 1, wherein the positive electrode has a multi-layered structure, and Li ions intercalate or de-intercalate between layers of the multi-layered structure of the positive electrode.

7. The Li-ion battery as claimed in claim 1, wherein the material of the positive electrode is talc, pyrophyllite, or a clay mineral.

8. The Li-ion battery as claimed in claim 7 wherein the clay mineral is Montmorillonite, Kaolinite, Illite, or Smectite.

9. The Li-ion battery as claimed in claim 1, wherein the thickness of the negative electrode is 50-1000 μm.

10. The Li-ion battery as claimed in claim 1, wherein the thickness of the negative electrode is 50-500 μm.
